(19) United States
(12) Patent Application Publication
(10) Pub. No.: US 2026/0318750 A1
(43) Pub. Date: Oct. 15, 2026

(54) TEMPERATURE-SENSING OPTICAL CABLE MOUNTING ASSEMBLY AND MOUNTING PROCESS THEREOF

(71) Applicants: INSTALLATION ENGINEERING CO., LTD. OF CCCC FIRST HARBOR ENGINEERING CO., LTD., TIANJIN (CN); CCCC FIRST HARBOR ENGINEERING CO., LTD., TIANJIN (CN); CCCC PETROLEUM PIPELINE ENGINEERING CO., LTD., Zhengzhou (CN)

(72) Inventors: Yan HU, TIANJIN (CN); Xianghui KONG, TIANJIN (CN); Tianqing ZHANG, TIANJIN (CN)

(21) Appl. No.: 19/691,447

(22) Filed: May 28, 2026

Related U.S. Application Data
(63) Continuation of application No. PCT/CN2025/123829, filed on Sep. 25, 2025.

(30) Foreign Application Priority Data
Dec. 2, 2024 (CN) 202411745247.6

(51) Int. Cl. G01K 1/14; G01K 11/32; G08B 17/06

(52) U.S. Cl. CPC G01K 1/14; G01K 11/32; G08B 17/06

(57) ABSTRACT

A temperature-sensing optical cable mounting assembly comprising a base (1), a support plate (2), a first fixing plate (3), a second fixing plate (4) and a compression spring (5). A side surface of the base (1) is a mounting surface (101), the support plate (2) and an end of the compression spring (5) are fixedly mounted on the mounting surface (101), the first fixing plate (3) is threadedly connected with a plurality of fixing bolts (6), each fixing bolts (6) passes through an adjustment hole (7) arranged on the support plate (2), the adjustment hole (7) is a slotted hole parallel to an axial of the compression spring (5), and a surface of the first fixing plate and a surface of the second fixing plate is respectively provided with a rubber pad. Further disclosed is a temperature-sensing optical cable mounting process.

This application is a continuation of the international application PCT/CN2025/123829 filed on Sep. 25, 2025, which claims the priority of Chinese Patent Application No. 202411745247.6, filed on Dec. 2, 2024, entitled “TEMPERATURE-SENSING OPTICAL CABLE MOUNTING ASSEMBLY AND MOUNTING PROCESS THEREOF”, in the China National Intellectual Property Administration, the contents of which are incorporated herein by reference in entirety.

### TECHNICAL FIELD

The present disclosure belongs to a field of optical cable mounting technology, and in particular, relates to a temperature-sensing optical cable mounting assembly and mounting process thereof.

### BACKGROUND ART

Fiber optic temperature-sensing technology is an advanced temperature-sensing technology with real-time, online, and multi-point temperature measurement capabilities. This technology uses a special medium called a temperature-sensing optical cable to combine the functions of a sensor and a signal transmission channel. The temperature information of the space where the optical fiber is located is converted into a backscattered light signal, which is then mediated, acquired, and processed to achieve the real-time display of the temperature information.

In the field of fire detection, fiber optic temperature-sensing technology demonstrates significant application value due to its multi-point real-time detection characteristic. For example, in tunnel engineering, by laying a temperature-sensing optical cable along the interior of the tunnel, temperature data from various locations within the tunnel can be collected in real time, thereby providing accurate temperature information for the fire early warning system.

However, in the actual mounting of a temperature-sensing optical cable, due to the lack of unified mounting standards and standardized mounting processes, construction workers mainly rely on their own experience to lay the cable, which leads to inconsistent mounting methods and frequent problems.

Currently, the two main mounting methods of cable tray mounting and suspension mounting each have significant drawbacks:
1. As for cable tray mounting: in this method, the temperature-sensing optical cable is laid within a cable tray. However, because the cable tray is used for both electrical cable laying and maintenance, the temperature-sensing optical cable is susceptible to mechanical damage, which leads to performance degradation. Furthermore, the lack of tensioning measures within the cable tray means that when the optical cable is laid over a long distance, there may be significant discrepancy between the temperature measurement and the actual location, which causes the fire alarm system to fail to accurately locate the fire source and delaying rescue efforts.
2. As for suspension mounting: this method suspends the temperature-sensing optical cable using steel wires. The steel wires need to be suspended, secured, and tensioned before the optical cable may be suspended. This method is not only complex, with extensive high-altitude work significantly increasing safety risks, but also creates an economic burden due to higher material and labor costs.

### SUMMARY

To address the shortcomings of related technology, the present disclosure provides a temperature-sensing optical cable mounting assembly and a mounting process thereof, which may solve the problems of easy damage, lack of tension, complex procedures, and high costs existing in prior temperature-sensing optical cable mounting methods.

A first aspect of the present disclosure provides a temperature-sensing optical cable mounting assembly, including:
a base, wherein a side surface of the base is a mounting surface;
a support plate, fixedly mounted on the mounting surface of the base, wherein the support plate is provided with an adjustment hole;
a first fixing plate, mounted on the support plate;
a second fixing plate, located between the first fixing plate and the base; and
a compression spring, wherein an end of the compression spring is fixedly connected to the mounting surface, another end of the compression spring is fixedly connected to the second fixing plate;
wherein the first fixing plate is threadedly connected with a plurality of fixing bolts, each of the plurality of fixing bolts passes through the adjustment hole; the adjustment hole is a slotted hole and is parallel to an axial of the compression spring;
the fixing bolt is configured to tighten to fix the first fixing plate with the support plate; and
a surface of the first fixing plate and a surface of the second fixing plate is respectively provided with a rubber pad, the two rubber pads are arranged opposite to each other; and when the fixing bolt is attached to an end of the adjustment hole away from the base, the compression spring is in a non-elastic deformation state, and each of the two rubber pads is attached to a temperature-sensing optical cable therebetween.

In some embodiments, a fine-tuning bolt is threadedly connected with the support plate, the fine-tuning bolt is parallel to the axis of the compression spring, and an inner end of the fine-tuning bolt extends into the adjustment hole.

In some embodiments, a handle is mounted on the second fixing plate, and the handle is located on a surface of the second fixing plate away from the first fixing plate.

In some embodiments, a guide post is mounted on the base, and the compression spring is sleeved on the guide post.

A second aspect of the present disclosure provides a temperature-sensing optical cable mounting assembly, including:
a base, wherein a side surface of the base is a mounting surface;
a support plate, wherein an end of the support plate is fixedly mounted on the mounting surface of the base, and the support plate is provided with an adjustment hole;
a first fixing plate, mounted on the support plate;
a second fixing plate, located between the first fixing plate and the base; and
a compression spring, wherein an end of the compression spring is fixedly connected to the mounting surface, another end of the compression spring is fixedly connected to the second fixing plate;
wherein the first fixing plate is threadedly connected with a plurality of fixing bolts, each of the plurality of fixing bolts passes through the adjustment hole; the adjustment hole is a slotted hole and is parallel to an axial of the compression spring;
the fixing bolt is configured to tighten to fix the first fixing plate with the support plate; and
a surface of the first fixing plate and a surface of the second fixing plate is respectively provided with a rubber pad, the two rubber pads are arranged opposite to each other.

In some embodiments, the temperature-sensing optical cable mounting assembly includes an initial state and a working state; in the initial state, the two rubber pads are respectively attached to two sides of the temperature-sensing optical cable, and an elastic deformation of the compression spring is zero; in the working state, the two rubber pads are respectively attached to the two sides of the temperature-sensing optical cable, and the compression spring is compressed to generate an elastic force acting on the second fixing plate, so that the first fixing plate and the second fixing plate clamp and fix the temperature-sensing optical cable between the two rubber pads through the two rubber pads.

In some embodiments, a fine-tuning bolt is threadedly connected to the support plate, the fine-tuning bolt is parallel to the axis of the compression spring, and an inner end of the fine-tuning bolt extends into the adjustment hole.

In some embodiments, a handle is mounted on the second fixing plate, and the handle is located on a surface of the second fixing plate away from the first fixing plate.

In some embodiments, a guide post is mounted on the base, and the compression spring is sleeved on the guide post.

A third aspect of the present disclosure provides a temperature-sensitive optical cable mounting process, using the temperature-sensitive optical cable mounting assembly according to any one of the temperature-sensing optical cable mounting assemblies of the first aspect and the second aspect, including:
S10: moving the first fixing plate of each temperature-sensitive optical cable mounting assembly towards the second fixing plate for a first time, wherein each first fixing plate is fixed when a moving distance reaches a first preset distance L₁;
S20: mounting a first temperature-sensitive optical cable mounting assembly on a tunnel roof at a front end, lifting a winch wound with the temperature-sensitive optical cable to a back side of the first temperature-sensitive optical cable mounting assembly, pulling an end of the temperature-sensitive optical cable from the winch, and clamping and fixing the end of the temperature-sensitive optical cable between a first fixing plate and a second fixing plate of the first temperature-sensitive optical cable mounting assembly;
S30: moving the winch backward, mounting a second temperature-sensitive optical cable mounting assembly on the tunnel roof adjacent to a front side of the winch, clamping and fixing the temperature-sensitive optical cable, which is pulled out as the winch moves, between the first fixing plate and the second fixing plate of the second temperature-sensitive optical cable mounting assembly, connecting the temperature-sensitive optical cable at a back side of the second temperature-sensitive optical cable mounting assembly to a tension gauge, pulling the tension gauge horizontally backward until a tension value of the tension gauge reaches a preset tension F, so that the temperature-sensitive optical cable between the second temperature-sensitive optical cable mounting assembly and the first temperature-sensitive optical cable mounting assembly is tightened; moving the winch backward sequentially in the above-mentioned manner, after each movement of the winch, mounting one temperature-sensing optical cable mounting assembly on the tunnel roof adjacent to the front side of the winch, and clamping and fixing the pulled temperature-sensing optical cable to a newly mounted temperature-sensing mounting assembly, connecting the tension gauge to the temperature-sensing optical cable at the back side of the newly mounted temperature-sensing mounting assembly and pulling the tension gauge horizontally backward until a tension value of the tension gauge reaches the preset tension F, so that the temperature-sensing optical cable between the newly mounted temperature-sensing mounting assembly and one adjacent temperature-sensing optical cable mounting assembly at a front side of the newly mounted temperature-sensing mounting assembly is tightened until the temperature-sensing mounting assembly is mounted to the tunnel roof at a back end, and the mounted temperature-sensing optical cable mounting assemblies are aligned on a same horizontal line;
S40: moving the first fixing plate of each temperature-sensing optical cable mounting assembly towards the second fixing plate one by one from front to back for a second time, fixing the first fixing plate when a moving distance reaches a second preset distance L₂; when a number of the temperature-sensing optical cable mounting assemblies that have completed the second time of moving reaches 40% of a total number of the temperature-sensing optical cable mounting assemblies, respectively mounting a limiting clamp on the temperature-sensing optical cable at a back side of each temperature-sensing optical cable mounting assembly that has not undergone the second time of moving, and each limiting clamp is attached to adjacent temperature-sensing optical cable mounting assembly at a front side of said limiting clamp;
S50: for each temperature-sensing optical cable mounting assembly that has not undergone the second time of moving, moving the first fixing plate of each temperature-sensing optical cable mounting assembly towards the second fixing plate one by one from front to back for the second time, and fixing the first fixing plate when a moving distance reaches the second preset distance L₂.

In some embodiments, the first preset distance is expressed as:

$${L}_{3} = \frac{a \times {F}_{max} \times 8 \times {D}^{3} \times n}{G \times {d}^{4} \times μ} ;$$

the second preset distance is expressed as:

$${L}_{2} = \frac{b \times {F}_{max} \times 8 \times {D}^{3} \times n}{G \times {d}^{4} \times μ} ;$$

the preset tension is expressed as: F=c×Fₘₐₓ;
where a is 80%, b is 90%, c is 85%, Fₘₐₓ is a tensile strength value of the temperature-sensing optical cable, D is a mean diameter of the compression spring, n is a number of active coils of the compression spring, G is a shear modulus of a material used for the compression spring, d is a wire diameter of the compression spring, and μ is a coefficient of friction between an outer sheath of the temperature-sensing optical cable and the rubber pads.

In some embodiments, a distance between adjacent temperature-sensing optical cable mounting assemblies is less than a preset distance L₃, and

$${L}_{3} = \sqrt{\frac{8}{q} \times \sqrt{1 - {b}^{2}} \times {F}_{max}} ;$$

where q is a weight of the temperature-sensing optical cable per meter.

In some embodiments, the temperature-sensing optical cable mounting assembly is mounted onto a leveling pad provided on the tunnel roof, and each of the temperature-sensing optical cable mounting assemblies is mounted at a same height and the temperature-sensing optical cable mounting assemblies are aligned in the front-to-back direction.

In some embodiments, in step S40, the limiting clamps are mounted one by one from back to front.

In some embodiments, when the temperature-sensing optical cable mounting assembly is mounted onto the tunnel roof, the temperature-sensing optical cable mounting assembly is mounted invertedly, the second fixing plate is placed above the first fixing plate, and the base is fixedly connected to the tunnel roof.

In some embodiments, in step S50, each time the second time of moving of one temperature-sensing optical cable mounting assembly is completed, one adjacent limiting clamp at the back side of said temperature-sensing optical cable mounting assembly is removed.

Compared with the existing art, the beneficial effects of the present disclosure are as follows: in the embodiments of the present disclosure, the temperature-sensing optical cable mounting assembly mounted on a building structure is used to clamp and fix the temperature-sensing optical cable, thereby achieving the mounting of the temperature-sensing optical cable. The process is simple, easy to operate, and low-cost. Furthermore, the clamping and fixing of the temperature-sensing optical cable maintains its tension after mounting, and keeps the temperature-sensing optical cable taut. The measured temperature and location correspondence is accurate. Since the temperature-sensing optical cable is mounted separately outside the cable tray, it will not be damaged, thereby solving the problems of easy damage, lack of tension, complex procedures, and high costs existing in current temperature-sensing optical cable mounting methods.

### BRIEF DESCRIPTION OF THE DRAWINGS

The drawings described herein are used to better understand of the present disclosure and form part of the present disclosure. The exemplary embodiments and descriptions of the present disclosure are used to explain the present disclosure, and do not constitute an improper limitation to the present disclosure. In the drawings:

FIG. 1 is a first schematic structural diagram of a temperature-sensing optical cable mounting assembly provided by the embodiments of the present disclosure;

FIG. 2 is a second schematic structural diagram of the temperature-sensing optical cable mounting assembly provided by the embodiments of the present disclosure;

FIG. 3 is a first schematic structural diagram of the temperature-sensing optical cable mounting assembly in an initial state during inverted mounting provided by the embodiments of the present disclosure;

FIG. 4 is a second schematic structural diagram of the temperature-sensing optical cable mounting assembly in the initial state during inverted mounting provided by the embodiments of the present disclosure;

FIG. 5 is a first schematic structural diagram of the temperature-sensing optical cable mounting assembly in a working state during inverted mounting provided by the embodiments of the present disclosure;

FIG. 6 is a second schematic structural diagram of the temperature-sensing optical cable mounting assembly in the working state during inverted mounting provided by the embodiments of the present disclosure;

FIG. 7 is a process flow diagram of a temperature-sensing optical cable mounting process provided by the embodiments of the present disclosure;

FIG. 8a is a first schematic diagram of the temperature-sensitive optical cable mounting process provided by the embodiments of the present disclosure;

FIG. 8b is a second schematic diagram of the temperature-sensitive optical cable mounting process provided by the embodiments of the present disclosure;

FIG. 8c is a third schematic diagram of the temperature-sensitive optical cable mounting process provided by the embodiments of the present disclosure;

FIG. 8d is a fourth schematic diagram of the temperature-sensitive optical cable mounting process provided by the embodiments of the present disclosure;

FIG. 8e is a fifth schematic diagram of the temperature-sensitive optical cable mounting process provided by the embodiments of the present disclosure;

FIG. 8f is a sixth schematic diagram of the temperature-sensitive optical cable mounting process provided by the embodiments of the present disclosure; and

FIG. 9 is a partial enlarged view of part A in FIG. 8f.

Wherein, 1 base; 101 mounting surface; 2 support plate; 3 first fixing plate; 4 second fixing plate; 5 compression spring; 6 fixing bolt; 7 adjustment hole; 8 rubber pad; 9 fine-tuning bolt; 10 handle; 11 guide post;
100 temperature-sensing optical cable; 200 temperature-sensing optical cable mounting assembly; 200-1 first temperature-sensing optical cable mounting assembly; 200-2 second temperature-sensing optical cable mounting assembly; 200-3 third temperature-sensing optical cable mounting assembly; 300 winch; 400 tension gauge; 500 limiting clamp; 600 mobile lifting platform vehicle; 700 leveling pad.

### DETAILED DESCRIPTION OF THE EMBODIMENTS

The technical solutions of the present disclosure will be described clearly and completely below with reference to the accompanying drawings of the embodiments of the present disclosure. Obviously, the described embodiments are partial embodiments of the present disclosure, but not all embodiments. Based on the described embodiments of the present disclosure, all other embodiments obtained by those of ordinary skilled in the art without creative effort fall within the protection scope of the present disclosure.

In the description of the present disclosure, it should be understood that the terms “center,” “lateral,” “longitudinal,” “upper,” “lower,” “front,” “rear,” “left,” “right,” “vertical,” “horizontal,” “top,” “bottom,” “inner,” and “outer,” etc., indicating orientation or positional relationships based on the orientation or positional relationships shown in the accompanying drawings, are used only for the convenience of describing the present disclosure and for simplification, and do not indicate or imply that the device or element referred to must have a specific orientation, or be constructed and operated in a specific orientation, and therefore should not be construed as a limitation of the present disclosure. In the description of the present disclosure, the expressions of orientation such as “front end,” “back end,” “front side,” and “back side” are based on the mounting direction of the temperature-sensing optical cable.

The terms “first,” “second,” and “third” are used for descriptive purposes only and should not be construed as indicating or implying relative importance or implicitly specifying the number of technical features indicated. Therefore, a feature defined with “first,” “second,” or “third” may explicitly or implicitly include one or more features.

In the description of the present disclosure, it should be noted that, unless otherwise expressly specified and limited, the terms “mounting,” “connection,” and “joining” should be interpreted broadly. For example, they may refer to a fixed connection, a detachable connection, or an integral connection; they may refer to a direct connection or an indirect connection through an intermediate medium; and they may refer to the internal communication between two components. Those skilled in the art may understand the specific meaning of the above terms in the present disclosure based on the specific circumstances.

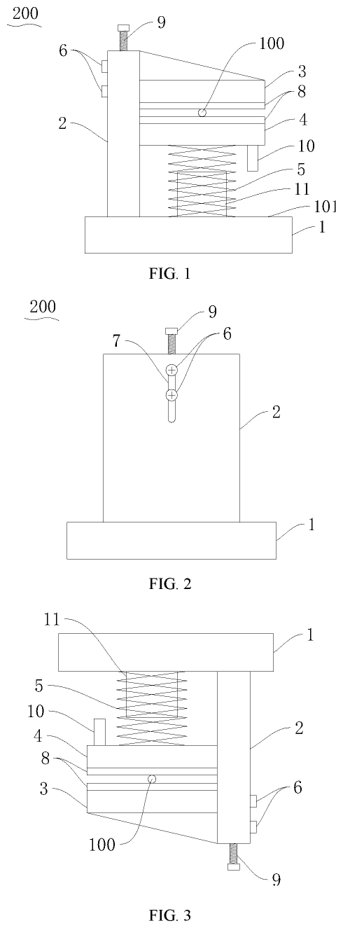

As shown in FIGS. 1 and 2, in a schematic embodiment of a temperature-sensing optical cable mounting assembly of the present disclosure, the temperature-sensing optical cable mounting assembly includes a base 1, a support plate 2, a first fixing plate 3, a second fixing plate 4, and a compression spring 5.

A side surface of the base 1 serves as a mounting surface 101. An end of the support plate 2 and an end of the compression spring 5 are both fixedly mounted on the mounting surface 101. The first fixing plate 3 is mounted on the support plate 2 by a fixing bolt 6. The second fixing plate 4 is located between the first fixing plate 3 and the base 1 and is fixedly connected to another end of the compression spring 5. A plurality of fixing bolts 6 are located in an adjustment hole 7 provided in the support plate 2. The adjustment hole 7 is a slotted hole and is parallel to an axial of the compression spring 5. A surface of the first fixing plate 3 and a surface of the second fixing plate 4 are each provided with a rubber pad 8, and the two rubber pads 8 are arranged opposite each other.

The adjustment hole 7 is the slotted hole, so that the adjustment hole 7 has an extended length, and a length direction of the adjustment hole 7 is parallel to the axial of the compression spring 5. The position of the first fixing plate 3 on the support plate 2 is adjusted by adjusting the position of the fixing bolt 6 in the adjustment hole 7.

It can be understood that the second fixing plate 4 is connected to the mounting surface 101 of the base 1 through the compression spring 5, and there is no fixed connection between the second fixing plate 4 and the support plate 2, so the position of the second fixing plate 4 relative to the support plate 2 is able to be changed.

In some embodiments, when the fixing bolt 6 is attached to an end of the adjustment hole 7 away from the base 1, the compression spring 5 is in a non-elastic deformation state, and the two rubber pads 8 are both attached to the temperature-sensing optical cable 100 between the two rubber pads. At this point, the temperature-sensing optical cable mounting assembly 200 is in an initial state, and the elastic deformation of the compression spring 5 is 0. The two rubber pads 8 are respectively attached to two sides of the temperature-sensing optical cable.

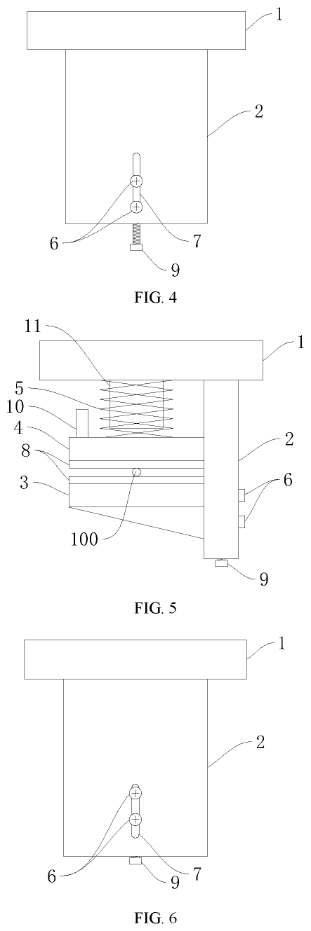

It should be understood that, in the initial state, “the fixing bolt 6 is attached to the end of the adjustment hole 7 away from the base 1” refers to the fixing bolt 6 that is farthest from the second fixing plate 4 among the plurality of fixing bolts 6 being attached to the end of adjustment hole 7 away from the base 1, as shown in FIG. 4.

Each of the plurality of fixing bolts 6 is loosened and slides along the adjustment hole 7 toward the second fixing plate 4, the first fixing plate 3 will then approach the second fixing plate 4, and then the fixing bolts 6 are tightened to secure the first fixing plate 3 even closer to the second fixing plate 4. At this point, the temperature-sensing optical cable mounting assembly 200 is in a working state, the two rubber pads 8 are respectively attached to the two sides of the temperature-sensing optical cable 100, and the compression spring 5 is compressed. The resulting elastic force acts on the second fixing plate 4, which causes the first fixing plate 3 and the second fixing plate 4 to clamp and fix the temperature-sensing optical cable between the two rubber pads through the two rubber pads 8.

The temperature-sensing optical cable mounting assembly 200 is adjusted to the working state and is fixed to a building structure. The base 1 is fixedly connected to the building structure. The temperature-sensing optical cable 100 is laid and is clamped and fixed to each temperature-sensing optical cable mounting assembly 200, thereby completing the laying and mounting of the temperature-sensing optical cable 100.

The temperature-sensing optical cable mounting assembly 200 is typically mounted upside down during use, that is, the base 1 is at the top, thereby placing the second fixing plate 4 above the first fixing plate 3. The temperature-sensing optical cable 100 is located between the second fixing plate 4 and the first fixing plate 3, and the compression spring 5 connects the second fixing plate 4 and the base 1. The temperature-sensing optical cable mounting assembly 200 includes the initial state and the working state. By adjusting the position of the fixing bolt 6 in the adjustment hole 7, the position of the first fixing plate 3 is changed, which allows the temperature-sensing optical cable mounting assembly 200 to be in either the initial state or working state.

As shown in FIGS. 3 and 4, when the temperature-sensing optical cable mounting assembly 200 is in the initial state, the first fixing plate 3 is fixed to a first position of the support plate, and at this point, the compression spring 5 is in the non-elastic deformation state.

In the initial state, since the compression spring 5 is in the non-elastic deformation state, the second fixing plate 4 and the temperature-sensing optical cable 100 are supported by the first fixing plate 3. The second fixing plate 4 mainly serves to provide a clamping surface in conjunction with the first fixing plate 3. In order to avoid the weight of the second fixing plate 4 affecting the pressure control acting on the temperature-sensing optical cable 100, the second fixing plate 4 may be made of a lightweight material, such as foam, so its influence is negligible.

Optionally, in the first position, one fixing bolt 6 farthest from the second fixing plate 4 among the plurality of fixing bolts 6 is attached to the end of the adjustment hole 7 farthest from the base 1.

As shown in FIGS. 5 and 6, when the temperature-sensing optical cable mounting assembly 200 is in the working state, the first fixing plate 3 is fixed to a second position of the support plate 2. This second position is closer to the base 1 than the first position, and the compression spring 5 is compressed. As the first fixing plate 3 moves closer to the base 1, the first fixing plate 3 pushes the temperature-sensing optical cable 100 and the second fixing plate 4 to move closer to the base 1, which causes the compression spring 5 to be compressed. The elastic restoring force generated by the compression spring 5 acts on the second fixing plate 4, thereby creating a clamping force between the second fixing plate 4 and the first fixing plate 1 on the temperature-sensing optical cable 100 located therebetween.

It is understood that, in the working state, the second position of the first fixing plate 3 is not a fixed position. The second position includes a plurality of different positions located adjacent to the second fixing plate 4 from the first position, specifically determined according to the required clamping force on the temperature-sensing optical cable 100. The temperature-sensing optical cable mounting assembly 200 is adjusted to the working state and is fixed on the building structure, the base 1 is fixedly connected to the building structure, the temperature-sensing optical cable 100 is laid and is clamped and fixed to each temperature-sensing optical cable mounting assembly 200, thereby realizing the laying and mounting of the temperature-sensing optical cable 100.

The temperature-sensing optical cable mounting assembly 200 provided in the embodiments of the present disclosure uses the compression spring 5 to provide the clamping force between the first fixing plate 3 and the second fixing plate 4 on the laid temperature-sensing optical cable 100, thereby clamping and fixing the temperature-sensing optical cable 100 and achieving stable mounting. The mounting and fixing operation using the temperature-sensing optical cable mounting assembly 200, as well as the clamping and fixing operation of the temperature-sensing optical cable 100, is relatively easy, simple, and low-cost. The clamping force on the temperature-sensing optical cable may be adjusted by changing the position of the first fixing plate 3. The temperature-sensing optical cable is firmly fixed while it has sufficient tension, so that the temperature-sensing optical cable remains taut, and the accuracy of the correlation between temperature and position is improved. The temperature-sensing optical cable is mounted independently using the temperature-sensing optical cable mounting assembly 200, which avoids damage caused by mounting in a cable tray, thereby solving the problems of easy damage, lack of tension, complex procedures, and high costs existing in current temperature-sensing optical cable mounting methods.

In some embodiments, as shown in FIGS. 1 to 6, a fine-tuning bolt 9 is threaded onto the support plate 2. The fine-tuning bolt 9 is parallel to the axis of the compression spring 5, and an inner end of the fine-tuning bolt 9 extends into the adjustment hole 7.

A graduation line is provided at a side of the adjustment hole 7. When the temperature-sensing optical cable mounting assembly 200 is in the initial state, an end of the graduation line is aligned with the fixing bolt 6 farthest from the second fixing plate 4 in the adjustment hole 7, and this fixing bolt 6 serves as a reference bolt. When the position of the first fixing plate 3 needs precise adjustment, the fixing bolt 6 is loosened, and the fine-tuning bolt 9 is rotated simultaneously, while keeping the fine-tuning bolt 9 against the reference bolt until the reference bolt moves to the required scale on the graduation line. By precisely adjusting the position of the reference bolt, the movement stroke of the first fixing plate 3 is precisely controlled, thereby ensuring accurate deformation of the compression spring 5 and providing sufficient pressure to maintain the stable clamping and fixing of the temperature-sensing optical cable 100.

In some embodiments, as shown in FIGS. 1 to 6, the fine-tuning bolt 9 is inserted at an end of the support plate 2 away from the base 1. An axis of the fine-tuning bolt 9 is parallel to the axis of the compression spring 5, and an end of the fine-tuning bolt 9 extends into the adjustment hole 7 and abuts against the fixing bolt 6. By rotating the fine-tuning bolt 9, the position of the fixing bolt 6 in the adjustment hole 7 can be adjusted, thereby achieving the precise adjustment.

In some embodiments, a graduation line is provided on the support plate 2 adjacent to the adjustment hole 7, and the graduation line is arranged along the length direction of the adjustment hole 7. The fixing bolt 6 farthest from the second fixing plate 4 (i.e., the fixing bolt 6 closest to the fine-tuning bolt 9) is used as a reference bolt. By rotating the fine-tuning bolt 9, the fine-tuning bolt 9 is pressed against the reference bolt and pushed it to move along the graduation line, which achieves precise adjustment of the position of the first fixing plate 3, thereby precisely controlling the deformation of the compression spring 5, and thus achieving precise control of the clamping force on the temperature-sensing optical cable 100.

In some embodiments, as shown in FIG. 1, a handle 10 is mounted on the second fixing plate 4 and is located on a surface of the second fixing plate 4 away from the first fixing plate 3. The handle 10 facilitates the application of an external force away from the first fixing plate 3 to the second fixing plate 4, compressing the compression spring 5 and pulling the rubber pad 8 on the second fixing plate 4 away from the rubber pad 8 on the first fixing plate 3. In this way, the temperature-sensing optical cable may be easily entered a gap between the two rubber pads 8, and clamps and fixes the temperature-sensing optical cable 100 after releasing the handle 10.

In some embodiments, as shown in FIG. 1, a guide post 11 is mounted on the base 1, and the compression spring 5 is sleeved on the guide post 11. The compression spring 5 is in sliding contact with an outer wall of the guide post 11, and the guide post 11 keeps the compression spring 5 axially deformed, which may provide pressure more accurately and sufficiently to maintain the clamping stability of the temperature-sensing optical cable.

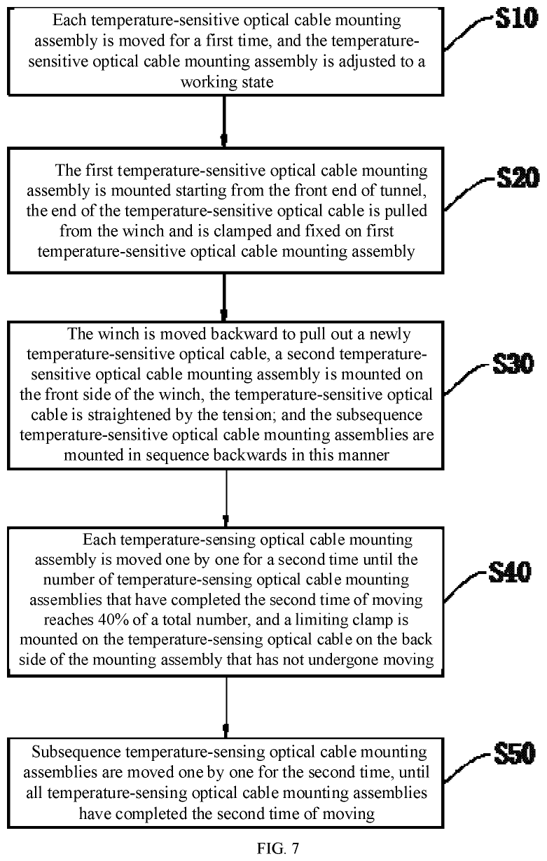

Based on the temperature-sensing optical cable mounting assembly 200, the present disclosure further provides a temperature-sensing optical cable mounting process, adopting the above-described temperature-sensing optical cable mounting assembly 200 to mount the temperature-sensing optical cable 100, as shown in FIG. 7, and including the following steps S10 to S40.

In step S10, a plurality of temperature-sensing optical cable mounting assemblies 200 are used; the first fixing plate 3 of each temperature-sensing optical cable mounting assembly 200 is moved towards the second fixing plate 4 for the first time; and each first fixing plate 3 is fixed when a moving distance of the first fixing plate 3 reaches a first preset distance L₁.

In step S10, before the first fixing plate 3 moves for the first time, the position of the first fixing plate 3 ensures that the temperature-sensing optical cable mounting assembly 200 is in the initial state, i.e., the first fixing plate 3 is located at the first position. When the first fixing plate 3 is fixed in the first position, and the temperature-sensing optical cable 100 is clamped between the first fixing plate 3 and the second fixing plate 4, the compression spring 5 is in the non-elastic deformation state. The first time of moving causes the first fixing plate 3 to move the first preset distance L₁ towards the base 1 relative to the position in the initial state.

The moving distance during the first time of moving is always the first preset distance L₁. After the first time of moving of each temperature-sensing optical cable mounting assembly 200 is completed, the corresponding first fixing plate 3 is fixed by tightening the fixing bolt 6, thereby adjusting each temperature-sensing optical cable mounting assembly 200 from the initial state to the working state.

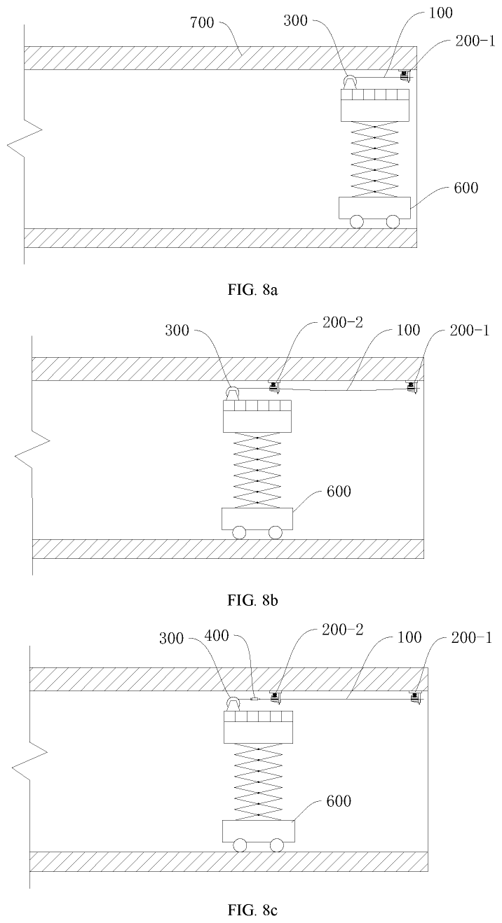

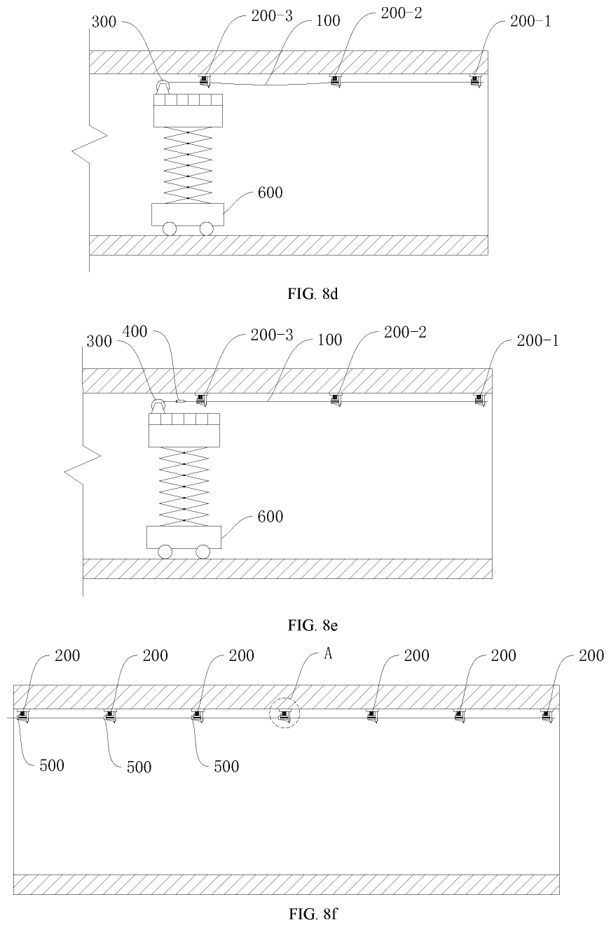

In step S20, as shown in FIG. 8a, a first temperature-sensing optical cable mounting assembly 200-1 is mounted on a tunnel roof at a front end of the tunnel. A winch 300 wound with the temperature-sensing optical cable 100 is lifted to a back side of the first temperature-sensing optical cable mounting assembly 200-1. One end of the temperature-sensing optical cable 100 is pulled out from the winch 300 and is clamped and fixed between the first fixing plate 3 and the second fixing plate 4 of the first temperature-sensing optical cable mounting assembly 200-1.

In some embodiments of step S20, when the temperature-sensing optical cable 100 is clamped between the first fixing plate 3 and the second fixing plate 4, the second fixing plate 4 is moved away from the first fixing plate 3 (for example, an external force may be applied by means of the handle 10 mounted on the second fixing plate 4), so that a gap is formed between the rubber pad 8 on the second fixing plate 4 and the rubber pad 8 on the first fixing plate 3, allowing the temperature-sensing optical cable 100 to enter. After the temperature-sensing optical cable 100 is placed in the gap, the external force acting on the second fixing plate 4 is removed, and under the action of the compression spring 5, the second fixing plate 4 is pushed towards the first fixing plate 3, so that the temperature-sensing optical cable 100 is clamped between the first fixing plate 3 and the second fixing plate 4.

In step S30, as shown in FIG. 8b, the winch 300 is moved backward. A second temperature-sensitive optical cable mounting assembly 200-2 is mounted on the tunnel roof adjacent to a front side of the winch 300. The temperature-sensitive optical cable 100, pulled out as the winch 300 moves, is clamped and fixed between the first fixing plate 3 and the second fixing plate 4 of the second temperature-sensitive optical cable mounting assembly 200-2, as shown in FIG. 8c. The temperature-sensitive optical cable at a back side of the second temperature-sensitive optical cable mounting assembly 200-2 (i.e., the temperature-sensitive optical cable 100 between the current winch 300 and the second temperature-sensitive optical cable mounting assembly 200-2) is connected with a tension gauge 400. The tension gauge 400 is pulled horizontally backward until a tension value thereof reaches the preset tension F, thereby pulling the temperature-sensitive optical cable through the tension gauge 400, and straightening and tightening the temperature-sensitive optical cable between the second temperature-sensitive optical cable mounting assembly 200-2 and the first temperature-sensitive optical cable mounting assembly 200-1. Next, the tension gauge 400 is removed.

As shown in FIG. 8d, the winch 300 is moved backward once more. After the winch 300 has moved, a third temperature-sensitive optical cable mounting assembly 200-3 is mounted on the tunnel roof adjacent to the front side of the winch. The newly pulled-out temperature-sensitive optical cable is clamped and fixed on the third temperature-sensitive optical cable mounting assembly 200-3, as shown in FIG. 8e. The tension gauge 400 is mounted on the temperature-sensitive optical cable 100 between the third temperature-sensitive optical cable mounting assembly 200-3 and the winch 300. The tension gauge 400 is pulled horizontally backward until a tension value thereof reaches the preset tension F. The temperature-sensitive optical cable between the third temperature-sensitive optical cable mounting assembly 200-3 and the second temperature-sensitive optical cable mounting assembly 200-2 is straightened and tightened. Next, the tension gauge 400 is removed.

According to the above-mentioned method, the winch 300 is moved backward multiple times. After each movement, a temperature-sensitive optical cable mounting assembly 200 is mounted at the front side of the winch 300, thus sequentially mounting the fourth, fifth, sixth . . . Nth temperature-sensitive optical cable mounting assembly, where N is a natural number greater than 6. All mounted temperature-sensitive optical cable mounting assemblies 200 are aligned on the same horizontal line.

Each time the winch 300 moves, the newly pulled-out temperature-sensitive optical cable 100 is first clamped and fixed to the newly mounted temperature-sensitive optical cable mounting assembly 200. Then, the tension gauge 400 is connected to the back end of the temperature-sensitive optical cable 100 and pulled horizontally backward. Each time the temperature-sensitive optical cable is pulled by the tension gauge 400, the tension value is the preset tension F, thereby straightening and tightening the temperature-sensitive optical cable between the newly mounted temperature-sensitive optical cable mounting assembly 200 and the adjacent temperature-sensitive optical cable mounting assembly 200 in front.

Finally, when the temperature-sensing mounting assembly is mounted on the tunnel roof at a back end of the tunnel, the winch is moved horizontally out of the tunnel from the back end. At this point, the mounting of all temperature-sensing mounting assemblies is completed from front to back on the tunnel roof, and each temperature-sensing mounting assembly effectively clamps and secures the temperature-sensing optical cable at the corresponding location.

In step S40, from front to back, the first fixing plate 3 of each temperature-sensing optical cable mounting assembly 200 is moved towards the second fixing plate 4 one by one for a second time. The first fixing plate is fixed when the moving distance reaches a second preset distance L₂.

After the second time of moving of each temperature-sensing optical cable mounting assembly 200, the fixing bolt 6 is tightened to fix the corresponding first fixing plate 3, thereby further increasing the elastic deformation of the compression spring 5 in the working state of the temperature-sensing optical cable mounting assembly 200 and improving the clamping force on the temperature-sensing optical cable.

The term “the moving distance reaches a second preset distance L₂” in step S40 means that the first fixing plate 3 moves a second preset distance L₂ relative to the position where the temperature-sensing optical cable mounting assembly 200 is in the initial state (i.e., the first position) towards the base 1. In other words, during the second time of moving, the actual distance moved by the first fixing plate 3 is L₂−L₁.

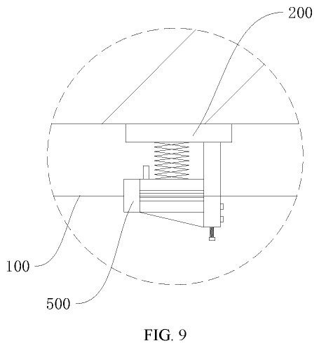

The first fixing plate 3 of the temperature-sensing optical cable mounting assembly 200 is moved for the second time from front to back; as shown in FIGS. 8f and 9, when the number of temperature-sensing optical cable mounting assemblies 200 that have completed the second time of moving of the first fixing plate 3 reaches 40% of the total number of temperature-sensing optical cable mounting assemblies 200, a limiting clamp is respectively mounted on the temperature-sensing optical cable on the back side of each temperature-sensing optical cable mounting assembly that has not undergone the second time of moving, and the limiting clamp is attached to adjacent temperature-sensing optical cable mounting assembly at a front side of the limiting clamp. As shown in FIG. 9, the limiting clamp 500 is a detachable clamp that holds the temperature-sensing optical cable tightly, protruding relative to the outer wall of the temperature-sensing optical cable, and attached to the temperature-sensing optical cable mounting assembly 200 to prevent the temperature-sensing optical cable from moving forward.

The limiting clamp 500 may be implemented using existing clamp structures. For example, the clamp consists of two semi-circular clamp pieces connected by a hinge, and the distance between the two clamp pieces is adjusted by a nut. Rubber anti-slip strips are provided on the inner side of the two clamp pieces.

In step S50, for each temperature-sensing optical cable mounting assembly 200 that has not undergone the second time of moving, that is, the temperature-sensing optical cable mounting assembly 200 with the limiting clamp mounted at the back side, moving the first fixing plate 3 towards the second fixing plate 4 one by one from front to back for the second time, and fixing the first fixing plate when the moving distance reaches the second preset distance L₂.

Thereby, the second time of moving of the first fixing plate 3 of subsequence temperature-sensing optical cable mounting assembly 200 is completed sequentially. After the second time of moving of each temperature-sensing optical cable mounting assembly 200 is completed, the corresponding first fixing plate 3 is fixed by tightening the fixing bolt 6.

In the temperature-sensing optical cable mounting process provided by the embodiments of the present disclosure, by controlling the moving distance of the first fixing plate 3, the deformation of the compression spring 5 during the clamping and fixing of the temperature-sensing optical cable by the temperature-sensing optical cable mounting assembly 200 is controlled, thereby controlling the clamping force.

In some embodiments, in step S10, before each temperature-sensing optical cable mounting assembly 200 is mounted and fixed to the tunnel roof, all temperature-sensing optical cable mounting assemblies 200 may be adjusted from the initial state to the working state on the ground, so that after the temperature-sensing optical cable mounting assemblies 200 are mounted on the tunnel roof, they may be immediately used for clamping and fixing the temperature-sensing optical cable 100.

In step S20, the first temperature-sensitive optical cable mounting assembly 200-1 is mounted starting from the front end, and it is used to clamp and fix the end of the temperature-sensitive optical cable, thereby providing a fixed foundation for the subsequent extraction of the temperature-sensitive optical cable from the winch 300.

In some embodiments, in order to ensure that the winch 300 and the mounted first temperature-sensitive optical cable mounting assembly 200-1 are adjacent to each other (i.e., the distance between the winch 300 and the mounted first temperature-sensitive optical cable mounting assembly is short), a mobile lifting platform vehicle 600 is used for the mounting of the temperature-sensitive optical cable mounting assembly 200.

Specifically, the winch 300 is fixed to the back end of the mobile lifting platform vehicle 600, and the mounting of the temperature-sensitive optical cable mounting assembly 200 is performed at the front end of the mobile lifting platform vehicle 600. The mobile lifting platform vehicle 600 has limited space, thereby ensuring that the winch 300 and the mounted temperature-sensitive optical cable mounting assembly 200 are adjacent to each other.

In step S30, by moving the mobile lifting platform vehicle 600 backwards in sequence, the winch 300 may be moved backwards and the new temperature-sensing optical cable may be pulled out. At the same time, a new temperature-sensing optical cable mounting assembly 200 is mounted on the mobile lifting platform vehicle 600 nearby, so that the new temperature-sensing optical cable mounting assembly 200 is set up adjacent to the winch 300 with a close distance.

In some embodiments, the first preset distance is expressed as

$${L}_{1} = \frac{a \times {F}_{max} \times 8 \times {D}^{3} \times n}{G \times {d}^{4} \times μ} ,$$

the second preset distance is expressed as

$${L}_{2} = \frac{b \times {F}_{max} \times 8 \times {D}^{3} \times n}{G \times {d}^{4} \times μ} ,$$

the preset tension is expressed as F=c×Fₘₐₓ, a is 80%, b is 90%, c is 85%, Fₘₐₓ is a tensile strength value of the temperature-sensing optical cable, D is a mean diameter of the compression spring, n is a number of active coils of the compression spring, G is a shear modulus of a material used for the compression spring, d is a wire diameter of the compression spring, and μ is a coefficient of friction between an outer sheath of the temperature-sensing optical cable and the two rubber pads 8.

The tensile strength value Fₘₐₓ and the coefficient of friction μ are obtained through performance tests in the laboratory. Since the temperature-sensing optical cable is clamped on both sides by rubber pads 8 of the same material, the accuracy of the coefficient of friction μ measurement is ensured. The mean diameter D, number of active coils n, and wire diameter d of the compression spring 5 are all dimensional parameters of the compression spring 5 and may be directly obtained. The shear modulus G is obtained by referring to a table based on the material used in the compression spring 5.

In the above embodiments, through precise calculation of the first preset distance L₁, when the elastic force generated by the compression spring 5 acts on the temperature-sensing optical cable 100 through the second fixing plate 4 and the rubber pads 8, a frictional force of approximately 80% of its tensile strength value may be generated on the temperature-sensing optical cable 100.

The preset tension is expressed as F=c×Fₘₐₓ, the tension gauge 400 is used to pull the temperature-sensitive optical cable 100. The temperature-sensing optical cable 100 is pulled tight until the tension on the temperature-sensing optical cable 100 reaches 85% of its tensile strength value. After clamping and securing the temperature-sensing optical cable 100 onto the temperature-sensing cable mounting assembly 200, it ensures sufficient tension to maintain the straightness of the temperature-sensing optical cable and accurately measurement of the temperature at various points along the tunnel.

When the temperature-sensing optical cable is pulled using the tension gauge 400, after the first time of moving, the clamping force of the temperature-sensing optical cable mounting assembly 200 generates a frictional force equivalent to 80% of the tensile strength value when applied to the temperature-sensing optical cable; the horizontal tension generated by pulling the temperature-sensing optical cable may overcome the frictional force and the reverse tension generated by the weight of the temperature-sensing optical cables between the temperature-sensing optical cable mounting assemblies 200, which allows the clamped temperature-sensing optical cable to move horizontally, thereby shortening the length of the temperature-sensing optical cable between adjacent temperature-sensing optical cable mounting assemblies 200, straightening this part of the temperature-sensing optical cable, and keeping the straightened temperature-sensing optical cable taut with a tension of 85% of the tensile strength value.

Further, when the temperature-sensing optical cable is pulled by the tension gauge 400, the temperature-sensing optical cable between the two temperature-sensing optical cable mounting assemblies 200 at the front side of the tension gauge 400 is not taut. The tension force acting on the temperature-sensing optical cable 100 by the tension gauge 400 first acts on the temperature-sensing optical cable between the first adjacent temperature-sensing optical cable mounting assembly 200 at the front side and the connection point of the tension gauge 400, this segment of temperature-sensing optical cable is only subjected to the friction force generated by the clamping of the first adjacent temperature-sensing optical cable mounting assembly 200 at the front side. The tension force can overcome the sum of the friction force and the reverse tension force generated by the weight of the temperature-sensing optical cable at the front side, which causes this segment of temperature-sensing optical cable to move backward under the action of the tension force, thereby taut and straightening the temperature-sensing optical cable between the first adjacent and second adjacent temperature-sensing optical cable mounting assemblies 200 at the front side. When the temperature-sensing optical cable is taut and straightened, the temperature-sensing optical cable will exert a horizontal pull on the second adjacent temperature-sensing optical cable mounting assembly 200 at the front side. At this time, due to the friction generated by the two temperature-sensing optical cable mounting assemblies 200 as resistance, and by using a tensile force of 85% of the tensile strength to pull the temperature-sensing optical cable, it will be unable to overcome the double friction force, thus maintaining fixation and tautness.

In step S40, the first fixing plate 3 of each temperature-sensing optical cable mounting assembly 200 is moved and adjusted for the second time from front to back. Through precise calculation of the second preset distance, when the elastic force generated by the compression spring 5 acts on the temperature-sensing optical cable through the second fixing plate 4 and the rubber pads 8, the friction force generated on the temperature-sensing optical cable is increased to about 90% of the tensile strength value, which enhances the clamping and fixing effect of the temperature-sensing optical cable and keeps the temperature-sensing optical cable stable under a tension force of 85% of the tensile strength value.

Furthermore, each time a temperature-sensing optical cable mounting assembly 200 is moved and adjusted for the second time, a certain height difference is created between the present temperature-sensing optical cable mounting assembly and the adjacent temperature-sensing optical cable mounting assembly 200, which results in tension on the temperature-sensing optical cables therebetween. In an initial stage of the second time of moving, the number of temperature-sensing optical cable mounting assemblies 200 that have completed the second time of moving is small; the sum of the frictional forces generated by the pressure acting on the temperature-sensing optical cables is less than the sum of the frictional forces generated by the temperature-sensing optical cable mounting assemblies 200 that have not undergone the second time of moving. Because the second time of moving causes tension between adjacent temperature-sensing optical cable mounting assemblies 200, it will not cause the temperature-sensing optical cable at the back side to be pulled forward and move, so as to remain stationary; and the resulting height difference is on the order of centimeters, and the horizontal spacing is on the order of ten meters, so that the resulting tension will not break the temperature-sensing optical cable. When 40% of the temperature-sensing optical cable mounting assemblies 200 have completed the second time of moving, increasing the number of temperature-sensing optical cable mounting assemblies 200 after the second time of moving will cause the front pulling force to be greater than the total frictional force at the back, which results in the temperature-sensing optical cable at the back side being pulled forward.

To avoid the above situation, in step S40, the limiting clamp 500 is fixedly mounted on the temperature-sensing optical cable. The limiting clamp 500 presses against the temperature-sensing optical cable mounting assembly 200, thereby preventing the temperature-sensing optical cable from moving forward under tension. Thus, after all the temperature-sensing optical cable mounting assemblies 200 have completed the second time of moving, each temperature-sensing optical cable between adjacent temperature-sensing optical cable mounting assemblies 200 is prevented from being displaced due to pulling and thus becoming slack.

Through step S50, the second time of moving of subsequent temperature-sensing optical cable mounting assemblies 200 is performed, thereby lifting all temperature-sensing optical cable mounting assemblies 200. The frictional force generated thereby is greater than the tension force of the temperature-sensing optical cable, thereby improving the stability of the temperature-sensing optical cable after mounting.

Finally, the entire temperature-sensing optical cable is securely clamped and fixed along the tunnel roof from front to back by each temperature-sensing optical cable mounting assembly 200, thereby ensuring stable mounting of the temperature-sensing optical cable. The temperature-sensing optical cable has sufficient tension to keeps taut, thereby guaranteeing accurate temperature measurement. The mounting process requires only the mobile lifting platform vehicle 600 and equipment for mounting the temperature-sensing optical cable mounting assemblies 200, which makes operation simple and convenient.

In some embodiments, a distance between adjacent temperature-sensing optical cable mounting assemblies 200 is less than a preset distance L₃,

$${L}_{3} = \sqrt{\frac{8}{q} \times \sqrt{1 - {b}^{2}} \times F \text{?}} ;$$

$$\text{?} \text{indicates text missing or illegible when filed}$$

where q is the weight of each meter of the temperature-sensing optical cable.

The distance between the temperature-sensing optical cable mounting assemblies 200 is accurately limited by the precise preset distance L₃, which ensures that the temperature-sensing optical cable between adjacent temperature-sensing optical cable mounting assemblies 200 does not bend or deform due to excessive length, thus preventing deformation and loosening of the temperature-sensing optical cable and maintaining effective tautness over a long period.

In some embodiments, due to poor flatness of the tunnel roof, the temperature-sensing optical cable mounting assembly 200 is mounted on a leveling pad 700 provided on the tunnel roof. That is, by using leveling pad 700 of corresponding thickness, each temperature-sensing optical cable mounting assembly 200 is adjusted to the same height and aligned in the front-to-back direction. This ensures that after clamping and fixing, the temperature-sensing optical cable 100 remains horizontal and coaxial, which allows accurate correspondence between the measured temperature and position of the temperature-sensing optical cable 100, and enables the fire early warning system to accurately locate the fire source.

The present disclosure does not limit the structure of the leveling pad, as long as the leveling pad may provide a lower surface on the same horizontal plane.

In some embodiments, in step S40, when mounting the limiting clamps 500, the limiting clamps are mounted one by one from back to front.

If the limiting clamps 500 are mounted starting from the middle of the entire temperature-sensing optical cable, with the heavy weight of the limiting clamps 500 acting on the middle section, which may cause the temperature-sensing optical cable to be pulled forward under their weight, which may lead the temperature-sensing optical cable to be slack.

The limiting clamps are mounted from back to front, the weight of the limiting clamps 500 will act in a backward pulling direction on the temperature-sensing optical cable, thereby preventing the temperature-sensing optical cable from becoming loose due to pressure caused by the mounting of the limiting clamps 500, keeping the temperature-sensing optical cable taut and straight, and maintaining the accuracy of the temperature measurement position.

In some embodiments, when mounting the temperature-sensing optical cable mounting assembly 200 onto the tunnel roof, it is mounted invertedly, with its second fixing plate 4 placed above the first fixing plate 3, and its base 1 fixedly connected to the tunnel roof.

When the temperature-sensing optical cable is clamped and fixed to the temperature-sensing optical cable mounting assembly 200 in the inverted manner, the temperature-sensing optical cable is placed on the rubber pad 8 on the first fixing plate 3. This ensures that each clamping and fixing point is aligned on the horizontal line, making it easier to avoid height differences and making it easier to mount the entire temperature-sensing optical cable in a horizontal state.

Further, the temperature-sensing optical cable mounting assembly 200 includes the fine-tuning bolt 9. The fine-tuning bolt 9 is inserted into the adjustment hole 7 from bottom to top, thereby pushing the fixing bolt 6 upwards during adjustment. The fixing bolt 6 rests on the fine-tuning bolt 9, and the axial movement of the fine-tuning bolt 9 accurately corresponds to the movement of the first fixing plate 3. This facilitates adjustment of the clamping force even after the temperature-sensing optical cable is already clamped and fixed.

In some embodiments, each time the second time of moving of a temperature-sensing optical cable mounting assembly 200 is completed, i.e., one adjacent limiting clamp 500 at the back side is removed, the pressure of the limiting clamp 500 on the temperature-sensing optical cable is quickly reduced, which ensures the stability of the temperature-sensing optical cable during mounting.

Finally, it should be noted that the various embodiments in the specification are described in a progressive manner, with each embodiment focusing on its differences from other embodiments. Similar or identical parts between embodiments may be referred to interchangeably.

The above embodiments are only used to illustrate the technical solutions of the present disclosure and not to limit them. Although the present disclosure has been described in detail with reference to preferred embodiments, those skilled in the art should understand that modifications may still be made to the specific implementation methods of the present disclosure or equivalent substitutions may be made to some technical features without departing from the spirit of the technical solutions of the present disclosure, and all such modifications should be covered within the scope of the technical solutions claimed in the present disclosure.

What is claimed is:

1. A temperature-sensing optical cable mounting assembly, comprising:
a base, wherein a side surface of the base is a mounting surface;
a support plate, fixedly mounted on the mounting surface of the base, wherein the support plate is provided with an adjustment hole;
a first fixing plate, mounted on the support plate;
a second fixing plate, located between the first fixing plate and the base; and
a compression spring, wherein a first end of the compression spring is fixedly connected to the mounting surface, a second end of the compression spring is fixedly connected to the second fixing plate;
wherein the first fixing plate is threadedly connected with a plurality of fixing bolts, each of the plurality of fixing bolts passes through the adjustment hole; the adjustment hole is a slotted hole and is parallel to an axial of the compression spring;
the fixing bolt is configured to tighten to fix the first fixing plate with the support plate; and
a surface of the first fixing plate and a surface of the second fixing plate is respectively provided with a rubber pad, the two rubber pads are arranged opposite to each other; and when the fixing bolt is attached to an end of the adjustment hole away from the base, the compression spring is in a non-elastic deformation state, and each of the two rubber pads is attached to a temperature-sensing optical cable between the two rubber pads.

2. The temperature-sensing optical cable mounting assembly according to claim 1, wherein a fine-tuning bolt is threadedly connected to the support plate, the fine-tuning bolt is parallel to the axis of the compression spring, and an inner end of the fine-tuning bolt extends into the adjustment hole.

3. The temperature-sensing optical cable mounting assembly according to claim 1, wherein a handle is mounted on the second fixing plate, and the handle is located on a surface of the second fixing plate away from the first fixing plate.

4. The temperature-sensing optical cable mounting assembly according to claim 1, wherein a guide post is mounted on the base, and the compression spring is sleeved on the guide post.

5. A temperature-sensing optical cable mounting assembly, comprising:
a base, wherein a side surface of the base is a mounting surface;
a support plate, wherein an end of the support plate is fixedly mounted on the mounting surface of the base, and the support plate is provided with an adjustment hole;
a first fixing plate, mounted on the support plate;
a second fixing plate, located between the first fixing plate and the base; and
a compression spring, wherein a first end of the compression spring is fixedly connected to the mounting surface, a second end of the compression spring is fixedly connected to the second fixing plate;
wherein the first fixing plate is threadedly connected with a plurality of fixing bolts, each of the plurality of fixing bolts passes through the adjustment hole; the adjustment hole is a slotted hole and is parallel to an axial of the compression spring;
the fixing bolt is configured to tighten to fix the first fixing plate with the support plate; and
a surface of the first fixing plate and a surface of the second fixing plate is respectively provided with a rubber pad, the two rubber pads are arranged opposite to each other.

6. The temperature-sensing optical cable mounting assembly according to claim 5, further comprising an initial state and a working state;
in the initial state, the two rubber pads are respectively attached to two sides of the temperature-sensing optical cable, and an elastic deformation of the compression spring is zero;
in the working state, the two rubber pads are respectively attached to the two sides of the temperature-sensing optical cable, and the compression spring is compressed to generate an elastic force acting on the second fixing plate, so that the first fixing plate and the second fixing plate clamp and fix the temperature-sensing optical cable between the two rubber pads through the two rubber pads.

7. The temperature-sensing optical cable mounting assembly according to claim 5, wherein a fine-tuning bolt is threadedly connected to the support plate, the fine-tuning bolt is parallel to the axis of the compression spring, and an inner end of the fine-tuning bolt extends into the adjustment hole.

8. The temperature-sensing optical cable mounting assembly according to claim 5, wherein a handle is mounted on the second fixing plate, and the handle is located on a surface of the second fixing plate away from the first fixing plate.

9. The temperature-sensing optical cable mounting assembly according to claim 5, wherein a guide post is mounted on the base, and the compression spring is sleeved on the guide post.

10. A temperature-sensitive optical cable mounting process, using the temperature-sensitive optical cable mounting assembly according to claim 5, comprising:
S10: moving the first fixing plate of each temperature-sensitive optical cable mounting assembly towards the second fixing plate for a first time, wherein each first fixing plate is fixed when a moving distance reaches a first preset distance L₁;
S20: mounting a first temperature-sensitive optical cable mounting assembly on a tunnel roof at a front end, lifting a winch wound with the temperature-sensitive optical cable to a back side of the first temperature-sensitive optical cable mounting assembly, pulling an end of the temperature-sensitive optical cable from the winch, and clamping and fixing the end of the temperature-sensitive optical cable between a first fixing plate and a second fixing plate of the first temperature-sensitive optical cable mounting assembly;
S30: moving the winch backward, mounting a second temperature-sensitive optical cable mounting assembly on the tunnel roof adjacent to a front side of the winch, clamping and fixing the temperature-sensitive optical cable, pulled out as the winch moves, between the first fixing plate and the second fixing plate of the second temperature-sensitive optical cable mounting assembly, connecting the temperature-sensitive optical cable at a back side of the second temperature-sensitive optical cable mounting assembly to a tension gauge, pulling the tension gauge horizontally backward until a tension value of the tension gauge reaches a preset tension F, so that the temperature-sensitive optical cable between the second temperature-sensitive optical cable mounting assembly and the first temperature-sensitive optical cable mounting assembly is tightened; moving the winch backward sequentially in the above-mentioned manner, after each movement of the winch, mounting one temperature-sensing optical cable mounting assembly on the tunnel roof adjacent to the front side of the winch, and clamping and fixing the pulled temperature-sensing optical cable to a newly mounted temperature-sensing mounting assembly, connecting the tension gauge to the temperature-sensing optical cable at the back side of the newly mounted temperature-sensing mounting assembly and pulling the tension gauge horizontally backward until a tension value of the tension gauge reaches the preset tension F, so that the temperature-sensing optical cable between the newly mounted temperature-sensing mounting assembly and one adjacent temperature-sensing optical cable mounting assembly at a front side of the newly mounted temperature-sensing mounting assembly is tightened until the temperature-sensing mounting assembly is mounted to the tunnel roof at a back end, and the mounted temperature-sensing optical cable mounting assemblies are aligned on a same horizontal line;
S40: moving the first fixing plate of each temperature-sensing optical cable mounting assembly towards the second fixing plate one by one from front to back for a second time, fixing the first fixing plate when a moving distance reaches a second preset distance L₂; when a number of the temperature-sensing optical cable mounting assemblies that have completed the second time of moving reaches 40% of a total number of the temperature-sensing optical cable mounting assemblies, respectively mounting a limiting clamp on the temperature-sensing optical cable at a back side of each temperature-sensing optical cable mounting assembly that has not undergone the second time of moving, and each limiting clamp is attached to adjacent temperature-sensing optical cable mounting assembly at a front side of said limiting clamp;
S50: for the temperature-sensing optical cable mounting assembly that has not undergone the second time of moving, moving the first fixing plate of each temperature-sensing optical cable mounting assembly towards the second fixing plate one by one from front to back for the second time, and fixing the first fixing plate when a moving distance reaches the second preset distance L₂.

11. The temperature-sensing optical cable mounting process according to claim 10, wherein,
the first preset distance is expressed as:
$${L}_{1} = \frac{a \times {F}_{max} \times 8 \times {D}^{3} \times n}{G \times {d}^{4} \times μ} ;$$
the second preset distance is expressed as:
$${L}_{2} = \frac{b \times {F}_{max} \times 8 \times {D}^{3} \times n}{G \times {d}^{4} \times μ} ;$$
the preset tension is expressed as: F=c×Fₘₐₓ;
where a is 80%, b is 90%, c is 85%, Fₘₐₓ is a tensile strength value of the temperature-sensing optical cable, D is a mean diameter of the compression spring, n is a number of active coils of the compression spring, G is a shear modulus of a material used for the compression spring, d is a wire diameter of the compression spring, and μ is a coefficient of friction between an outer sheath of the temperature-sensing optical cable and the rubber pads.

12. The temperature-sensing optical cable mounting process according to claim 11, wherein a distance between adjacent temperature-sensing optical cable mounting assemblies is less than a preset distance L₃, and
$${L}_{3} = \sqrt{\frac{8}{q} \times \sqrt{1 - {b}^{2}} \times F \text{?}} ;$$
$$\text{?} \text{indicates text missing or illegible when filed}$$
where q is a weight of the temperature-sensing optical cable per meter.

13. The temperature-sensing optical cable mounting process according to claim 10, wherein the temperature-sensing optical cable mounting assembly is mounted onto a leveling pad provided on the tunnel roof, and each of the temperature-sensing optical cable mounting assemblies is mounted at a same height and the temperature-sensing optical cable mounting assemblies are aligned in the front-to-back direction.

14. The temperature-sensing optical cable mounting process according to claim 10, wherein in step S40, the limiting clamps are mounted one by one from back to front.

15. The temperature-sensing optical cable mounting process according to claim 10, wherein when the temperature-sensing optical cable mounting assembly is mounted onto the tunnel roof, the temperature-sensing optical cable mounting assembly is mounted invertedly, the second fixing plate is placed above the first fixing plate, and the base is fixedly connected to the tunnel roof.

16. The temperature-sensing optical cable mounting process according to claim 10, wherein in step S50, each time the second time of moving of one temperature-sensing optical cable mounting assembly is completed, one adjacent limiting clamp adjacent at the back side of said temperature-sensing optical cable mounting assembly is removed.
